(19) United States
(12) Patent Application Publication
(10) Pub. No.: US 2007/0118302 A1
(43) Pub. Date: May 24, 2007

(54) MULTI-BODY PROBLEM COMPUTING APPARATUS AND METHOD

(75) Inventor: Kazuhiko Watanabe, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Corporation

(21) Appl. No.: 11/562,845

(22) Filed: Nov. 22, 2006

(30) Foreign Application Priority Data
Nov. 24, 2005 (JP) 2005-339149

(51) Int. Cl. G06F 19/00

(52) U.S. Cl. 702/41

(57) ABSTRACT

A force/virial calculator selects one of a plurality of miniature cells divided from a basic cell having a periodic boundary condition, sequentially selects a particle included in the miniature cell, and calculates a force exerted by the particle on a particle intended for calculation. A sum total calculator accumulates the value of the force exerted on the particle intended for calculation by each of the particles included in the miniature cell, derived in the force/virial calculator, to derive the sum total of the forces, and supplies the sum total of the forces to the force/virial calculator. The force/virial calculator multiplies the sum total of forces by a constant value previously determined for the miniature cell, thereby deriving a virial exerted by the miniature cell on the particle intended for calculation.

This application is based upon and claims the benefit of priority from Japanese Patent Application No. 2005-339149 filed on Nov. 24, 2005, the content of which is incorporated by reference.

### BACKGROUND OF THE INVENTION

1. Field of the Invention

The present invention relates to a multi-body problem computing apparatus.

2. Description of the Related Art

In the field of molecular dynamics, the behavior of liquids, solids, polymers and the like are regarded as the result of the motion of atoms or molecules which constitute them, and motions of these particles are simulated in research. The multi-body problem refers to a problem that involves a system comprised of a multiplicity of particles which interact with one another, and the molecular dynamics involve calculations of multi-body problems in which atoms and molecules are regarded as particles. In the field of astronomy and geophysics, the multi-body problem is also used to simulate the movement of planetsin a planet movement simulation and the like in which planets are regarded as particles.

Because of the interaction between particles in a system handled in the multi-body problem, the force that acts on the particles is an important physical value in the multi-body problem, and is therefore always calculated. The force that acts on a certain particle represents the sum total of forces that acted on all other particles.

Also, the pressure and volume of material will change due to a change in temperature, and a change in volume means a change in the position of the particles, so that pressure is an important physical value as well. Further, a virial, which is used to detect the pressure is also calculated frequently as an important physical amount. The virial is derived by multiplying each component of a force acting between particles by the difference between respective coordinates. The pressure can be calculated from the sum total of virials within a system.

Apparatuses for calculating a virial by multiplying the difference in coordinates between two particles by a force acting between the two particles are disclosed in JP-A-6-176005 and JP-A-8-287042.

FIG. 1 is a block diagram illustrating the configuration of an existing computing apparatus. This computing apparatus is disclosed in JP-A-6-176005. Referring to FIG. 1, the existing computing apparatus comprises coordinate difference calculation unit 91, squared distance calculation unit 92, function calculation unit 93, delay unit 94, force calculation unit 95, virial calculation unit 96, force summation unit 97, and virial summation unit 98.

Assume herein that within a multiplicity of particles existing in a system, particle i represents a particle intended for calculation, and particle j represents other particles which affect particle i.

Calculation of a force that acts on one particle may involve adding all forces that are calculated by using a particle that is intended for calculation that is fixed to single particle i and each of all other particles that are substituted into particle j.

A calculation of a virial for one particle, in turn, may involve adding all virials which are calculated using a particle that is to be calculated and that is fixed to particle 1 and each of all the other particles that are substituted into particle j. Further, a calculation of the sum total of the virials within the system may involve adding all virials calculated using all particles within the system that are substituted into particle i, and dividing the sum by two. The division by two is herein made in order to eliminate virials which are added twice when every particle is substituted into particle i and when the particle is substituted into particle j.

The coordinates of particle i are represented by (xᵢ, yᵢ, zᵢ), and particle j by (xⱼ, yⱼ, zⱼ). The magnitude of the force that particle j exerts on particle i is represented by F.

Coordinate difference calculation unit 91 is applied with the coordinates of two particles i, j, and calculates coordinate differences Δxⱼ, Δyⱼ, Δzⱼ in accordance with Equations (1)-(3):
Δxⱼ=xⱼ−xᵢ (1)
Δyⱼ=yⱼ−yᵢ (2)
Δzⱼ=zⱼ−zᵢ (3)

Squared distance calculation unit 92 calculates a square of inter-particle distance r from the difference derived in coordinate difference calculation unit 91 in accordance with Equation (4):
r²=(Δxⱼ)²+(Δyⱼ)²+(Δzⱼ)² (4)

Function calculation unit 93 is applied with the square of inter-particle distance r derived in squared distance calculation unit 92, and calculates value F/r by dividing force F, that particle j exerts on particle i, by inter-particle distance r. While a force acting between particles is expressed by different forms of functions depending on the type of the force and the type of the particles, the value is uniquely determined in any case when inter-particle distance r is determined. Thus, force F can be derived from the square of inter-particle distance r, and value F/r can be derived by dividing the force by the distance.

Delay unit 94 delays coordinate differences Δxⱼ, Δyⱼ, Δzⱼ derived in coordinate difference calculation unit 91. This delay is provided for adjusting the time required for the calculation in function calculation unit 93.

Force calculation unit 95 is applied with coordinate differences Δxⱼ, Δyⱼ, Δzⱼ from delay unit 94, and value F/r, which is a division of the force by the inter-particle distance, from function calculation unit 93, and calculates components Fx, Fy, Fz of the force in the respective directions of coordinate axes in accordance with Equations (5)-(7):
Fₓ=F×(Δxⱼ/r)=(F/r)×Δxⱼ (5)
F_{y}=F×(Δyⱼ/r)=(F/r)×Δyⱼ (6)
F_{z}=F×(Δzⱼ/r)=(F/r)×Δzⱼ (7)

Virial calculation unit 96 is applied with coordinate differences Δxⱼ, Δyⱼ, Δzⱼ from delay unit 94, and is applied with force components Fx, Fy, Fz from force calculation unit 95, and calculates virial components Vx, Vy, Vz in the respective directions of coordinate axes in accordance with Equations (8)-(10):
Vₓ=Fₓ×Δxⱼ (8)
V_{y}=F_{y}×Δyⱼ (9)
V_{z}=F_{z}×Δzⱼ (10)

Force summation unit 97 is applied with components Fx, Fy, Fz of the force by particle j, from force calculation unit 95, where every particle other than particle i is substituted into particle j, and calculates the sum total of forces exerted by all particles j to particle i.

Virial summation unit 98 is applied with components Vx, Vy, Vz of the virial by particle j, from virial calculation unit 96, where every particle other than particle i is substituted into particle j, and calculates the sum total of virials for particle i.

Alternatively, virial summation unit 98 may add all calculation results of virial summation unit 98, while all particles within the system are substituted into particle i in sequence, and may divide the sum by two to calculate the sum total of the virials within the system.

This conventional computing apparatus is capable of calculating both of the forces and the sum total thereof as well as calculating the virials and the sum total thereof.

However, the foregoing prior art has problems as mentioned below.

The conventional multi-body problem computing apparatus requires a circuit for calculating the sum total of forces and a circuit for calculating the sum total of virials as separate hardware components, resulting in an increase in the overall apparatus that has a large size circuit. The conventional multi-body problem computing apparatus also discloses a configuration which shares a multiplier circuit for calculating forces and virials, and which uses the multiplier circuit in a time-division manner, thereby reducing the size of hardware. However, according to this configuration, a calculation circuit calculates the force and the virial for each particle j, and hence suffers from lower calculation speeds.

### SUMMARY OF THE INVENTION

It is an object of the present invention to provide a multi-body problem computing apparatus having a smaller size circuit while preventing lower calculation speeds.

To achieve the above object, a multi-body problem computing apparatus of the present invention is a multi-body problem computing apparatus for calculating a force and a virial which act between particles in a system to which a periodic boundary condition is applied, which includes a force/virial calculator and a sum total calculator.

The force/virial calculator selects one of a plurality of miniature cells divided from a basic cell of a periodic boundary condition, sequentially selects a particle included in the miniature cell, and calculates the force that a particle exerts on a particle that is to be calculated. The sum total calculator accumulates the value of the force that is exerted on the particle on which a calculation is to be performed from each of the particles included in the miniature cell, and that is derived in the force/virial calculator, to derive the sum total of the forces, and supplies the sum total of the forces to the force/virial calculator. After having selected all particles included in the miniature cell, the force/virial calculator multiplies the sum total of forces by the constant value previously determined for the miniature cell, thereby deriving a virial exterted by the miniature cell to the particle intended for calculation.

Thus, according to the present invention, the force/virial calculator sequentially selects a particle included in a selected miniature cell, and calculates a force that is exerted on a particle that is to be calculated. The sum total calculator accumulates the value of the force that each particle exerts on the particle on which a calculation will be performed to derive the sum total of the forces. The same force/virial calculator which calculates the force multiplies the sum total of the forces by a constant value, thereby deriving a virial exerted by the miniature cell to the particle intended for calculation. Consequently, the same force/virial calculator can be shared for calculating the force and virial which leads to a reduction in the size of the circuit. Also, the virial can be derived in a short time by multiplying an accumulated value of a plurality of forces by a constant value.

The above and other objects, features, and advantages of the present invention will become apparent from the following description with references to the accompanying drawings which illustrate examples of the present invention.

### BRIEF DESCRIPTION OF THE DRAWINGS

FIG. 1 is a block diagram illustrating the configuration of an existing computing apparatus;

FIG. 2 is a block diagram illustrating the configuration of a multi-body problem computing apparatus according to one embodiment;

FIG. 3 is a flow chart illustrating the operation of the multi-body problem computing apparatus according to one embodiment; and

FIG. 4 is a block diagram illustrating the detailed configuration of a force/virial calculation unit and a summation unit in the multi-body problem computing apparatus of the embodiment.

### DETAILED DESCRIPTION OF THE PREFERRED EMBODIMENTS

One embodiment for implementing the present invention will be described in detail with reference to the drawings.

Assume herein that particle i represents a central particle that is to be calculated, and particle j represents any other particle within a multiplicity of particles within a system.

As described above, the calculation of a force acting on one particle may involve adding all forces which are calculated that use with a particle intended for calculation fixed to single particle i, and that use each of all other particles substituted into particle j.

A calculation of a virial for one particle, in turn, may involve adding all virials which are calculated by using a particle that is tentended for calculation that is fixed to single particle i and each of all the other particles that are substituted into particle j. Further, the calculation of the sum total of the virials within the system may involve adding all virials calculated for all particles within the system substituted into particle i, and dividing the sum by two. The division by two is made herein in order to eliminate virials which are added twice because if all virials are added by substituting all the particles within the system into particle i, the total virials would include those which are calculated when all particles are substituted into particle i and those which are calculated when they are substituted into particle j.

In molecular dynamics, a periodic boundary condition is often used. Assume that this periodic boundary condition can be applied to a system of this embodiment. A system to which the periodic boundary condition is applied can be divided into basic cells which are equivalent to one another and which are repeated at a predetermined period.

In this embodiment, each basic cell of the periodic boundary condition is sub-divided into a plurality of miniature cells, a cell list is created for each miniature cell, and a cell list method is employed for calculations. The cell list records the coordinates of all particles within a miniature cell.

The sum total Vxx of all particles i of X-coordinate diagonal components of a virial exerted by every particle j to particle i, the sum total Vyy of all particles i of Y-coordinate diagonal components, and the sum total Vzz of all particles i of Z-coordinate diagonal components are represented by Equations (11)-(13), respectively.

$$\begin{matrix}{V}_{xx} = \frac{1}{2} {\sum }_{i} {\sum }_{i} {f}_{xij} \{ {x}_{j} - ( {x}_{j} \pm L x ) \} & ( 11 ) \\ {V}_{yy} = \frac{1}{2} {\sum }_{i} {\sum }_{i} {f}_{yij} \{ {y}_{j} - ( {y}_{j} \pm L y ) \} & ( 12 ) \\ {V}_{zz} = \frac{1}{2} {\sum }_{i} {\sum }_{i} {f}_{zij} \{ {z}_{j} - ( {z}_{i} - ( {z}_{i} \pm {L}_{z} ) \} & ( 13 )\end{matrix}$$

where Lx is the length of the basic cell in the X-axis direction, Ly is the length of the basic cell in the Y-axis direction, and Lz is the length of the basic cell in the Z-axis direction. Also, the coordinates of particle i are represented by (xᵢ, yᵢ, zᵢ), and the coordinates of particle j by (xⱼ, yⱼ, zⱼ).

Also, fₓᵢⱼ represents a component of a force exerted by particle j on particle i in the x-axis direction, i.e., the same as Fx shown in Equation (5). F_{yij} is a component of the force exerted by particle j on particle i in the y-axis direction, i.e., the same as Fy shown in Equation (6). F_{zij} is a component of the force exerted by particle j on particle i in the z-axis direction, i.e., the same as Fz shown in Equation (7).

{xⱼ−(xᵢ±Lx)} in Equation (11) represents the difference of X-coordinate between particle i and particle j, and is the result of mirroring from a periodic boundary condition. “xⱼ−(xⱼ±Lx)” becomes “xⱼ−(xᵢ+Lx)” when xⱼ−xᵢ>Lx/2; “xⱼ−(xᵢ±Lx)” when xⱼ−xᵢ<−Lx/2; and “xⱼ−xᵢ” when −Lx/2≦xⱼ−xᵢ≦Lx/2. Likewise, {yⱼ−(yᵢ±Ly)} represents the difference of Y-coordinate between particle i and particle j with mirroring. {zⱼ−(zᵢ±Lz)} represents the difference of Z-coordinate between particle i and particle j with mirroring.

Since the X-axis, Y-axis and Z-axis can all be handled in a similar manner, attention is herein paid to Equation (11) of the X-axis.

Equation (11) can be transformed into Equation (14) when it is expanded. Here, fₓⱼᵢ represents a force exerted by particle i on particle j, and is equivalent to (−fₓᵢⱼ). Taking into consideration that every particle is substituted into particle i and particle j, ΣxjΣ(−fₓⱼᵢ) in Equation (14) is the same even when particle i is replaced with particle j, so that Equation (14) can be transformed into Equation (15). Then, Equation (15) can further be transformed into Equation (16).

$$\begin{matrix}{V}_{xx} = \frac{1}{2} \{ {\sum }_{j} {x}_{j} {\sum }_{i} ( - {j}_{xji} ) - {\sum }_{i} ( {x}_{i} \pm {L}_{x} ) {\sum }_{j} {f}_{xij} \} & ( 14 ) \\ {V}_{xx} = \frac{1}{2} \{ - {\sum }_{i} {x}_{j} {\sum }_{j} {f}_{xij} - {\sum }_{i} ( {x}_{i} \pm {L}_{x} ) {\sum }_{j} {f}_{xij} \} & ( 15 ) \\ {V}_{xx} = - {\sum }_{i} ( {x}_{i} \pm \frac{{L}_{x}}{2} ) {\sum }_{j} {f}_{xij} & ( 16 )\end{matrix}$$

Now paying attention to Equation (15), this equation represents the use of the coordinates of particle i without mirroring one-half of all the number of particles i when calculating virials for all particles i. In other words, when xᵢ is used instead of (xᵢ±Lx) under condition j>i, Equation (16) can employ (xᵢ±Lx) which is a mirrored coordinate, and can be converted to Equation (17):

$${V}_{xx} = {\sum }_{i} ( {x}_{i} \pm {L}_{x} ) {\sum }_{j} {f}_{xij} \qquad ( 17 )$$

In Equation (17), (Σfₓᵢⱼ) is the sum total of forces exerted by all particles j on particle i. Here, this sum total of forces is considered for each miniature-cell.

Since (xᵢ±Lx) is determined by the relationship between xⱼ−xᵢ and L/2, −L/2, it can be said that this is a value determined by the X-coordinate of particle j if particle i is fixed. Assuming that (xᵢ±Lx) is constant for all particles j within a certain miniature cell α, the sum total of virials exerted by all particles j, within a certain miniature cell, to one particle i is calculated by calculating the sum total of forces exerted by all particles j within miniature cells to particle i, and multiplying the resulting sum total of the forces by constant value (xᵢ±Lx).

Also, the sum total of virials exerted by all particles j within the system to one particle i can be calculated as the sum total for all miniature cells within the system, of the sum total of the virials calculated for each miniature cell.

Further, the sum total of virials for all particles i within the system can be calculated as the sum total for all particles i within the system, of the sum totals of the virials calculated for respective particle i.

First, a description will be given of the configuration of a multi-body problem computing apparatus according to one embodiment of the present invention.

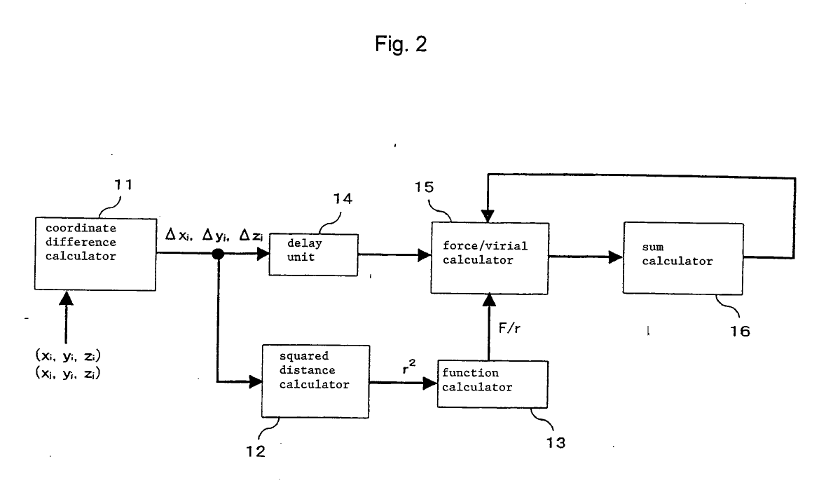

FIG. 2 is a block diagram illustrating the configuration of the multi-body problem computing apparatus according to this embodiment. Referring to FIG. 2, the multi-body problem computing apparatus of this embodiment comprises coordinate difference calculator 11, squared distance calculator 12, function calculator 13, delay unit 14, force/virial calculator 15, and sum calculator 16.

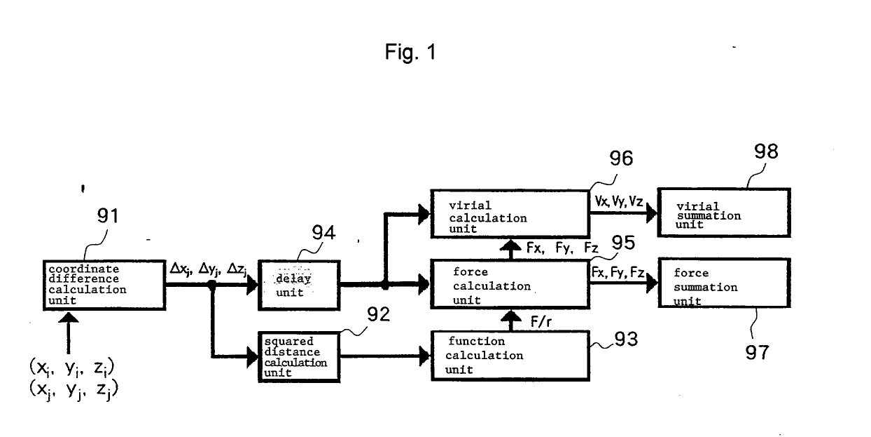

Coordinate difference calculator 11, which is the same as coordinate difference calculation unit 91 in FIG. 1, is applied with the coordinates of two particles i, j, and calculates coordinate differences Δxⱼ, Δyⱼ, Δzⱼ in accordance with Equations (1)-(3).

Squared distance calculator 12, which is the same as squared distance calculation unit 92 in FIG. 1, calculates a square of inter-particle distance r from the differences derived in coordinate difference calculator 11 in accordance with Equation (4).

Function calculator 13, which is the same as function calculation unit 93 in FIG. 1, is applied with the square of inter-particle distance r derived in squared distance calculator 12, and calculates value F/r by dividing force F exerted by particle j on particle i by inter-particle distance r. While a force acting between particles is determined by different forms of function depending on the type of the force and the type of the particles, the value is uniquely determined in any case when inter-particle distance r is determined. Thus, force F can be derived from the square of inter-particle distance r, and value F/r can be derived by dividing the force by the distance.

Delay unit 14, which is the same as delay unit 94 in FIG. 1, delays coordinate differences Δxⱼ, Δyⱼ, Δzⱼ derived in coordinate difference calculator 11. This delay is provided for adjusting the time required for the calculation in function calculator 13.

Force/virial calculator 15 calculates both force and virial.

In this event, force/virial calculator 15 first calculates the force which is exerted by each of particles j included in a certain miniature cell to particle i in sequence. In this embodiment, this calculation is performed in accordance with Equations (5)-(7). The calculation results are sequentially accumulated in sum total holder 16. The accumulated result is eventually equal to the sum total of forces exerted on particle i by all particles j included in the miniature cell, and is represented by (Σfₓᵢⱼ, Σf_{yij}, Σf_{zij}) for particles j in the miniature cell. In this connection, this component (Σfₓᵢⱼ) in the X-axis direction is included in Equation (14), and the component in the Y-axis direction and component in the Z-axis direction can be considered in a similar manner.

Upon completion of the calculation of the forces for all particles j included in the miniature cell, force/virial calculator 15 next calculates the sum total of virials from all particles j included in the miniature cell, from the sum total of the forces accumulated in sum total holder 16. This calculation involves multiplying the sum total of the forces exerted on particle i from all particles j included in the miniature cell by a constant value determined by the position of the miniature cell. The calculation is represented by (Σfₓᵢⱼ)*(xᵢ±Lx) in view of the X-axis direction.

By repeating the foregoing calculations for each miniature cell, force/virial calculator 15 calculates the sum total of virials from particles j included in each miniature cell for all miniature cells. The calculation results are sequentially accumulated in sum total holder 16.

By repeating the foregoing calculations for each particle i, force/virial calculator 15 further calculates the sum total of virials exerted on particle i by all particle j within the system for all particles i within the system. The calculation results may be sequentially accumulated in sum total holder 16.

Sum total calculator 16 sequentially accumulates the value of a force exerted on particle i by each of particles j included in the miniature cell, derived in force/virial calculator 15, and holds the result of this accumulation. The accumulation result (Σfₓᵢⱼ), upon completion of the accumulation of the forces from all particles j included in the miniature cell, is used for the calculation of virials in force/virial calculator 15.

Also, sum total calculator 16 sequentially accumulates the sum total of virials exerted on particle i by all particles j included in the miniature cell, and holds the accumulation result. This accumulation may be performed until the sum total has been derived for the virials affected to certain particle i from all particles j in all miniature cells, or until the sum totals have been accumulated for all particles i. The sum totals accumulated for all particles i is represented by Equation (14).

Next, a description will be given of the operation of the multi-body problem computing apparatus according to this embodiment.

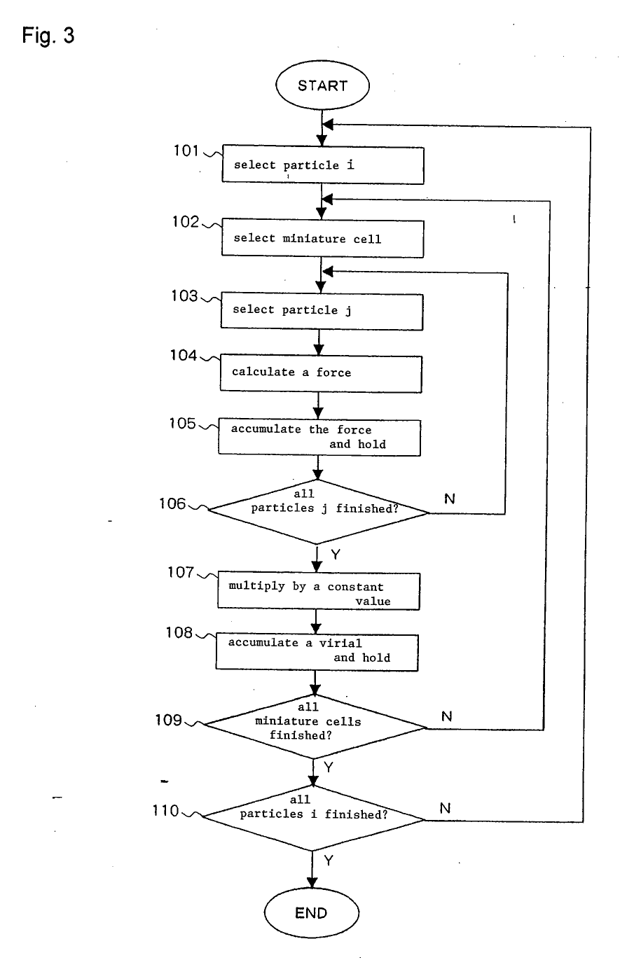

FIG. 3 is a flow chart illustrating the operation of the multi-body problem computing apparatus according to this embodiment. Referring to FIG. 3, the multi-body computing apparatus first selects one particle i which is intended for calculation (step 101). Next, the multi-body problem computing apparatus selects one miniature cell for calculating a force exerted on particle i (step 102). Next, the multi-body problem computing apparatus selects one particle j within the miniature cell (step 103).

Then, the multi-body problem computing apparatus calculates a force exerted on selected particle i by selected particle j (step 104), accumulates the result of the calculation, and holds the same (step 105).

Here, the multi-body problem computing apparatus determines whether or not the force has been calculated for all particles j within the selected miniature cell (step 106). If the calculation has not been completed for all particles j, the multi-body problem computing apparatus returns to step 103 to select next particle j.

If the calculation has been completed for all particles j, the multi-body problem computing apparatus next multiplies the accumulation result by a constant value determined by the miniature cell to derive a virial (step 107), accumulates the calculation result, and holds the same (step 108).

Here, the multi-body problem computing apparatus determines whether or not the virials have been calculated for all miniature cells within the system (step 109). If virials have not been calculated for all miniature cells, the multi-body problem computing apparatus returns to step 102 to select the next miniature cell.

If virials have been calculated for all the miniature cells, the multi-body problem computing apparatus next determines whether or not the sum total of virials has been calculated for all particles i (step 110). If the sum total of virials has not been calculated for all particles i, the multi-body problem computing apparatus returns to step 101 to select next particle i. If the sum total of virials has been calculated for all particles i, the multi-body problem computing apparatus terminates the processing.

It should be noted that the flow chart of FIG. 3 represents the calculation of the sum total of virials exerted on all particles i by all particles j within all the miniature cells, as an example of the maximum.

However, it is also possible, as a matter of course, to calculate the sum total of virials exerted on one specific particle i by all particles j in all the miniature cells. In this event, the processing at steps 102-109 may be executed with particle i being fixed.

Alternatively, it is also possible to calculate the sum total of virials affected to one specific particle i from all particles j in certain one miniature cell. In this event, the processing at steps 103-107 may be executed with particle i and miniature cell being fixed.

Next, a description will be given of the detailed configuration and operation of force/virial calculator 15 and sum total calculator 16.

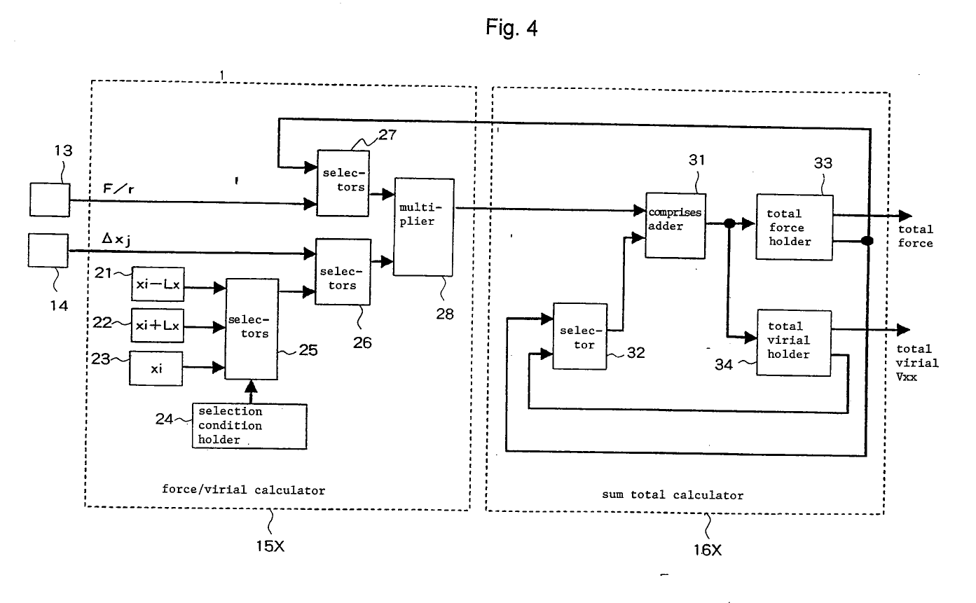

FIG. 4 is a block diagram illustrating the detailed configuration of the force/virial calculator and sum total calculator in the multi-body problem computing apparatus according to this embodiment. For purposes of description, FIG. 4 illustrates only components associated with the component in the X-axis direction.

Referring to FIG. 4, force/virial calculator 15X comprises xᵢ−Lx holder 21, xᵢ+Lx holder 22, xᵢ holder 23, selection condition holder 24, selectors 25-27, and multiplier 28. Sum total calculator 16X comprises adder 31, selector 32, total force holder 33, and total virial holder 34.

Xᵢ−Lx holder 21 of force/virial calculator 15X holds the value of (xᵢ−Lx) for selected particle i. Length Lx of a basic cell in the X-axis direction has a constant value determined from a periodic boundary condition. When particle i is determined, xᵢ, which is the x-coordinate thereof, is uniquely determined.

Xᵢ+Lx holder 22 holds the value of (xᵢ+Lx) for selected particle i.

Xᵢ holder 23 holds the value of Xᵢ for selected particle i.

Selection condition holder 24 maintains a condition under which a selection is made for a constant value by which the sum total of forces is multiplied in order to derive a virial exerted on particle i by particle j included in a certain miniature cell. Here, whether to select (xᵢ−Lx), (xᵢ+Lx), or xᵢ is determined from the relationship between a miniature cell to which particle i belongs and a miniature cell to which particle j belongs. Selection condition holder 24 stores the corresponding relationship, for example, in the form of table, and is applied with the miniature cell to which particle i belongs and a miniature cell to which particle j belongs, to supply a predetermined selection signal to selector 25.

Selector 25 selects a constant value by which the sum total of forces is multiplied in order to calculate the virial exerted on particle i by particle j included in a certain miniature cell in accordance with the selection signal from selection condition holder 24.

Selector 26 selects either Δxⱼ from delay unit 14 or the constant value from selector 25 as a value supplied to multiplier 28. Selector 26 selects Δxⱼ from delay unit 14 when a force is being calculated. Selector 26 selects the constant value from selector 25 when a virial is being calculated.

Selector 27 selects either F/r from function calculator 13 or the sum total of forces from total force holder 33 of sum total calculator 16, as a value supplied to multiplier 28. Selector 27 selects F/r from function calculator 13 when a force is being calculated. Selector 27 selects the sum total of forces from total force holder 33 when a virial is being calculated.

Specifically, at step 104 in the flow chart of FIG. 3, selector 26 selects Δxⱼ from delay unit 14, while selector 27 selects F/r from function calculator 13. On the other hand, at step 107, selector 26 selects the constant value from selector 25, while selector 27 selects the sum total of forces from total force holder 33.

Multiplier 28 multiplies the value supplied from selector 27 by the value supplied from selector 26. Multiplier 28 is used for calculating both the force and virial in response to the selections in selectors 26, 27.

Adder 31 of sum total calculator 16X adds the value from multiplier 28 of force/virial calculator 15X and the value from selector 32. Adder 31 is used for accumulating both forces and virials in response to the selection in selector 32 and the selections in selectors 26, 27 of force/virial calculator 15X.

Selector 32 selects either the sum total of forces from total force holder 33 or the sum total of virials from total virial holder 34. Selector 32 selects the sum total of forces from total force holder 33 when the forces are being accumulated. Selector 33 selects the sum total of virials from total virial holder 34 when the virials are being accumulated.

Total force holder 33 holds the value resulting from the accumulation of the forces performed in adder 31.

Total virial holder 34 holds the value resulting from the accumulation of the virials performed in adder 31.

Specifically, at step 105 in the flow chart of FIG. 3, selector 32 selects the sum total of forces from total force holder 33, while total force holder r33 captures the value from adder 31. On the other hand, at step 108, selector 32 selects the sum total of virials from total virial holder 34, while total virial holder 34 captures the value from adder 31.

Though not shown in FIG. 4, when the length of the basic cell is represented by Ly in the Y-axis direction and by Lz in the Z-axis direction, similar processes in the X-axis direction can be applied to the Y-axis direction and Z-axis direction.

As described above, according to this embodiment, force/virial calculator 15 sequentially selects particles j included in a selected miniature cell to calculate a force exerted on particle i, sum total calculator 16 accumulates the value of the force exerted on particle i by each particle j to derive the sum total of the forces, and force/virial calculator 15, identical to the calculator which calculates the force, multiplies the sum total of the forces by a constant value to derive a virial exerted on particle i by the miniature cell, so that the same force/virial calculator 15 can be shared in the calculations of forces and virials to reduce the size of circuit, and the virial can be calculated in a short time by multiplying the accumulated value of a plurality of forces by a constant value.

Also, according to this embodiment, since the virials exerted on particle i by miniature cells within a system can be accumulated by sequentially selecting the miniature cells, the sum total of virials exerted on particle i by particles j within the system can be derived in a small size circuit and in a short calculation time.

Further, according to this embodiment, since virials mutually exerted between particles within a system can be accumulated by sequentially selecting miniature cells and particles i, the sum total of virials within the system can be derived in a small size circuit and in a short calculation time.

Furthermore, according to this embodiment, in force/virial calculator 15, the same circuit can be shared in the multiplication for calculating a force and in the multiplication for calculating a virial, and in sum total calculator 16, the same circuit can be shared in the addition for accumulating forces and in the addition for accumulating virials.

While the multi-body problem computing apparatus according to this embodiment multiplies Σfₓᵢⱼ by (xᵢ±Lx) in order to use the mirrored coordinates, the present invention is not limited to this case. In FIG. 4, xᵢ−Lx holder 21 may be replaced with an xᵢ−Lx/2 holder, xᵢ+Lx holder 22 may be replaced with an xᵢ+Lx/2 holder, and selection condition holder 24 may select (xᵢ±Lx) even under the condition of j>i. In doing so, the sum total of virials can be calculated by multiplying Σfₓᵢⱼ by (xᵢ±Lx/2), from Equation (16), without twice adding the influence of mirroring even in the event of calculating the virial exerted by particle i on particle j.

While preferred embodiments of the present invention have been described using specific terms, such description is for illustrative purposes only, and it is to be understood that changes and variations may be made without departing from the spirit or scope of the following claims.

What is claimed is:

1. A multi-body problem computing apparatus for calculating a force and a virial which act between particles in a system to which a periodic boundary condition is applied, said apparatus comprising:
a force/virial calculator for selecting one of a plurality of miniature cells divided from a basic cell of a periodic boundary condition, sequentially selecting a particle included in the miniature cell to calculate a force exerted by the particle on a particle intended for calculation, and for multiplying the sum total of forces by a constant value previously determined for the miniature cell after having selected all particles included in the miniature cell, thereby deriving a virial exerted by the miniature cell on the particle intended for calculation; and
a sum total calculator for accumulating the value of the force exerted on the particle intended for calculation by each of the particles included in the miniature cell, derived in said force/virial calculator, to derive the sum total of the forces, and supplying the sum total of the forces to said force/virial calculator.

2. The multi-body problem computing apparatus according to claim 1, wherein:
said force/virial calculator sequentially selects the plurality of miniature cells included in the system, and calculates a virial exerted on the particle intended for calculation by each of the miniature cells, and
said sum total calculator accumulates the value of the virial exerted on the particle intended for calculation by each of the plurality of miniature cells, derived in said force/virial calculator, to derive the sum total of the virials exerted on the particle intended for calculation by the plurality of miniature cells.

3. The multi-body problem computing apparatus according to claim 1, wherein:
said force/virial calculator sequentially selects the plurality of particles within the system as particles intended for calculation, and calculates a virial exerted on each of the particles intended for calculation by each of the plurality of miniature cells, and
said sum total calculator accumulates the values of the virials exerted on the plurality of particles intended for calculation by each of the plurality of miniature cells, derived in said force/virial calculator, to derive the sum total of the virials within the system.

4. The multi-body problem computing apparatus according to claim 2, wherein:
said force/virial calculator is applied with differences Δxⱼ=xⱼ−xᵢ, Δyⱼ=yⱼ−yᵢ, and Δzⱼ=zⱼ−zᵢ of respective coordinate components between the coordinates (xᵢ, yᵢ, zᵢ) of particle i which is the particle intended for calculation and the coordinates (xⱼ, yⱼ, zⱼ) of particle j which affects a force and a virial to the particle intended for calculation, and is applied with F/r calculated by dividing the magnitude F of the force affected to the particle i from the particle j by the distance r between the particle j and the particle i, and is applied with the sum total of the forces derived in said sum total calculator, said force/virial calculator calculates the force by multiplying the F/r by each of the Σxⱼ, Σyⱼ, Σzⱼ, and calculates the virial by multiplying the sum total of the forces by the value of each component xᵢ, yᵢ, zᵢ of the coordinates of the particle i, which is the constant value, or each of values xᵢ±Lx, yᵢ±Ly, zᵢ±Lz calculated by adding or subtracting the length Lx, Ly, Lz of the basic cell in each axial direction to or from the value of xᵢ, yᵢ, zᵢ,
said sum total calculator is provided with the result of the multiplication of said force/virial calculator, and said sum total calculator accumulates the value of the force by adding and holding the value of the force derived as the result of the multiplication from said force/virial calculator and an accumulated value of forces up to the preceding multiplication in each axial direction, and accumulates the value of the virial by adding and holding the value of the virial derived as the result of the multiplication from said force/virial calculator and an accumulated value of virials up to the preceding multiplication in each axial direction.

5. The multi-body problem computing apparatus according to claim 4, wherein:
said force/virial calculator comprises:
a first selector applied with the F/r and the sum total of the forces for selecting and delivering the F/r when a force is calculated, and for selecting and delivering the sum total of the force when a virial is selected;
a second selector applied with the differences Δxⱼ, Δyⱼ, Δzⱼ of respective coordinate components and the constant values xᵢ±Lx, yᵢ±Ly, zᵢ±Lz, for selecting and delivering the differences Δxⱼ, Δyⱼ, Δzⱼ when the force is calculated, and for selecting and delivering the constant values i±Lx, yᵢ±Ly, zᵢ±Lz when the virial is selected; and
a multiplier for multiplying the outputs of said first selector and said second selector to supply the product to said sum total calculator, and
said sum total calculator comprises:
a total force holder for holding the accumulated value of the forces;
a total virial holder for holding the accumulated value of the virials;
a third selector for selecting and delivering the value held in said total force holder when the value of the force is accumulated, and for selecting and delivering the value held in said total virial holder when the value of the virial is accumulated; and
an adder for adding the output of said multiplier of said force/virial calculator and the output of said selector to supply the sum to said total force holder or to said total virial holder.

6. A multi-body problem computing apparatus for calculating a force and a virial which act between particles in a system to which a periodic boundary condition is applied, said apparatus comprising:
force/virial calculating means for selecting one of a plurality of miniature cells divided from a basic cell having a periodic boundary condition, for sequentially selecting a particle included in the miniature cell to calculate a force exerted by the particle on a particle intended for calculation, and for multiplying the sum total of forces by a constant value previously determined for the miniature cell after having selected all particles included in the miniature cell, thereby deriving a virial exerted by the miniature cell on the particle intended for calculation; and
sum total calculating means for accumulating the value of the force which exerted on the particle intended for calculation by each of the particles included in the miniature cell, and which derived in said force/virial calculating means, to derive the sum total of the forces, and for supplying the sum total of the forces to said force/virial calculator.

7. A multi-body problem computing method for calculating a force and a virial which act between particles in a system to which a periodic boundary condition is applied, wherein:
a force/virial calculator selects one of a plurality of miniature cells divided from a basic cell having a periodic boundary condition, sequentially selects a particle included in the miniature cell, and calculates a force exerted by the particle on a particle intended for calculation,
a sum total calculator accumulates the value of the force exerted on the particle intended for calculation by each of the particles included in the miniature cell to derive the sum total of the forces, and
said force/virial calculator multiplies the sum total of forces by a constant value previously determined for the miniature cell, thereby deriving a virial exerted by the miniature cell on the particle intended for calculation.

8. The multi-body problem computing method according to claim 7, wherein:
said force/virial calculator sequentially selects the plurality of miniature cells included in the system, and calculates a virial exerted on the particle intended for calculation by each of the miniature cells, and
said sum total calculator accumulates the value of the virial exerted on the particle intended for calculation by each of the plurality of miniature cells, derived in said force/virial calculator, to derive the sum total of the virials exerted on the particle intended for calculation by the plurality of miniature cells.

9. The multi-body problem computing method according to claim 7, wherein:
said force/virial calculator sequentially selects the plurality of particles within the system as particles intended for calculation, and calculates a virial exerted on each of the particles intended for calculation by each of the plurality of miniature cells, and
said sum total calculator accumulates the values of the virials exerted on the plurality of particles intended for calculation by each of the plurality of miniature cells, derived in said force/virial calculator, to derive the sum total of the virials within the system.

10. A multi-body problem computing method for calculating a force and a virial which act between particles in a system to which a periodic boundary condition is applied, said method comprising the steps of:
a force/virial calculator selecting one of a plurality of miniature cells divided from a basic cell having a periodic boundary condition, sequentially selecting a particle included in the miniature cell, and calculating a force exerted by the particle on a particle intended for calculation;
a sum total calculator accumulating the value of the force exerted on the particle intended for calculation by each of the particles included in the miniature cell to derive the sum total of the forces; and
said force/virial calculator multiplying the sum total of forces by a constant value previously determined for the miniature cell, thereby deriving a virial exerted by the miniature cell on the particle intended for calculation.
